(19) United States
(12) Patent Application Publication
(10) Pub. No.: US 2024/0291045 A1
(43) Pub. Date: Aug. 29, 2024

(54) NON-AQUEOUS RECHARGEABLE BATTERY

(71) Applicants: PRIMEARTH EV ENERGY CO., LTD., Kosai-shi, Shizuoka (JP); TOYOTA JIDOSHA KABUSHIKI KAISHA, Toyota-shi, Aichi-ken (JP); PRIME PLANET ENERGY & SOLUTIONS, INC., Tokyo (JP)

(72) Inventor: Takaaki IZUMOTO, Toyohashi-shi (JP)

(73) Assignees: PRIMEARTH EV ENERGY CO., LTD., Kosai-shi, Shizuoka (JP); TOYOTA JIDOSHA KABUSHIKI KAISHA, Toyota-shi, Aichi-ken (JP); PRIME PLANET ENERGY & SOLUTIONS, INC., Tokyo (JP)

(21) Appl. No.: 18/518,940

(22) Filed: Nov. 24, 2023

(30) Foreign Application Priority Data
Nov. 28, 2022 (JP) 2022-188993

(51) Int. Cl. H01M 10/0587; H01M 10/04; H01M 10/0525

(52) U.S. Cl. CPC H01M 10/0587; H01M 10/0431; H01M 10/0525

(57) ABSTRACT

A non-aqueous rechargeable battery includes an electrode body and a non-aqueous electrolyte solution. The electrode body includes positive and negative electrode plates and a separator. The negative electrode plate includes a substrate and a mixture layer applied to opposite surfaces of the substrate. When A represents a sum of a mass (mg/cm²) of an active material in the mixture layer per unit area on each substrate surface, B represents a lattice volume change amount (nm³) of the active material when the battery is charged from SOC 0% to 100%, C represents a change amount of the load (N) acting on the electrode body if the battery is charged from SOC 0% to 100%, D represents a sum (mm/kN) of a reciprocal of the positive electrode plate spring constant and a reciprocal of the separator spring constant, and E=A×B/(C×D) is satisfied, E is between 0.48 to 0.69, inclusive.

### BACKGROUND

### 1. Field

The present disclosure relates to a non-aqueous rechargeable battery.

### 2. Description of Related Art

A non-aqueous rechargeable battery is used as a power source for a battery electric vehicle and a hybrid electric vehicle. One example of a non-aqueous rechargeable battery is a lithium-ion battery that includes an electrode body, which is a stack of positive and negative electrode plates separated by a separator.

When the non-aqueous rechargeable battery is repeatedly charged and discharged at a high rate, the negative electrode active material of the negative electrode plate repeatedly expands and contracts. This expels non-aqueous electrolyte solution out of the electrode body. As a result, the non-aqueous electrolyte solution becomes unevenly distributed in the electrode body, and the amount of the non-aqueous electrolyte solution inside the electrode body becomes locally insufficient. This increases the battery resistance. In one example of a technique that reduces uneven distribution of the non-aqueous electrolyte solution in the electrode body, the spring constant of the positive plate in its thickness direction is set to be in a predetermined range in order to balance the amount of non-aqueous electrolyte solution expelled out of the positive electrode plate and the amount of non-aqueous electrolyte solution expelled out of the negative electrode plate (for example, refer to Japanese Laid-Open Patent Publication No. 2017-123236).

### SUMMARY

The expanded negative electrode active material presses the separator in addition to the positive electrode plate. To limit uneven distribution of the non-aqueous electrolyte solution in the electrode body, in addition to the deformation behavior of the positive electrode plate resulting from expansion of the negative electrode active material, the deformation behavior of the separator should also be taken into consideration.

A non-aqueous rechargeable battery in accordance with one aspect of the present disclosure includes an electrode body and a non-aqueous electrolyte solution. The electrode body includes a positive electrode plate, a negative electrode plate, and a separator that are stacked in a stacking direction. The separator is located between the positive electrode plate and the negative electrode plate. The negative electrode plate includes a negative electrode substrate and a negative electrode mixture layer applied to two surfaces of the negative electrode substrate that face opposite directions. When A represents a sum of a mass (mg/cm²) of a negative electrode active material included in the negative electrode mixture layer per unit area on each of the surfaces of the negative electrode substrate, B represents a lattice volume change amount (nm³) of the negative electrode active material when the non-aqueous rechargeable battery is charged from an SOC of 0% to 100%, C represents a change amount of the load (N) acting in the stacking direction on the electrode body when the non-aqueous rechargeable battery is charged from the SOC of 0% to 100%, D represents a sum (mm/kN) of a reciprocal of a spring constant of the positive electrode plate and a reciprocal of the spring constant of the separator in the stacking direction, and E=A×B/(C×D) is satisfied, E has a value in a range of 0.48 to 0.69, inclusive.

The value of A×B is an index indicating the value change amount resulting from expansion and contraction of the negative electrode active material as a result of charging and discharging. Thus, the value of A×B is an index indicating the amount of non-aqueous electrolyte solution expelled out of the negative electrode plate by the expansion and contraction of the negative electrode active material. The value of C×D has a positive correlation with the displacement amount when expansion of the negative electrode active material during charging compresses the separator and the positive electrode plate in the stacking direction. Thus, the value of C×D is an index indicating the volume change amount (decrease amount) of the separator and the positive electrode plate during charging, that is, an index indicating the amount of non-aqueous electrolyte solution expelled out of the separator and the positive electrode plate. By setting the ratio of the value of the value of A×B to C×D within a proper range, the amount of non-aqueous electrolyte solution expelled out of the negative electrode plate as a result of charging and discharging is properly balanced with the amount of non-aqueous electrolyte solution expelled out of the separator and the positive electrode plate.

In the non-aqueous rechargeable battery, E has a value of 0.56 or greater. This allows an increase in the resistance of the non-aqueous rechargeable battery, resulting from the charge-discharge cycle, to be avoided.

Preferably, in the non-aqueous rechargeable battery, C has a value in a range of 1650 N to 1700 N, inclusive. This allows the amount of the non-aqueous electrolyte solution expelled out of the positive electrode plate and the separator as a result of charging and discharging to be maintained properly.

In the non-aqueous rechargeable battery, A has a value in a range of 7.0 mg/cm² to 10.0 mg/cm², inclusive. This allows the amount of the non-aqueous electrolyte solution expelled out of the negative electrode plate as a result of charging and discharging to be maintained properly.

In the non-aqueous rechargeable battery, D has a value of 0.00011 mm/kN to 0.00012 mm/kN, inclusive. This allows the amount of the non-aqueous electrolyte solution expelled out of the positive electrode plate and the separator, as a result of charging and discharging, to be maintained properly.

### BRIEF DESCRIPTION OF THE DRAWINGS

FIG. 1 is a perspective view of a lithium-ion rechargeable battery.

FIG. 2 is a cross-sectional view of an electrode body in an unrolled state.

FIG. 3 is a cross-sectional view taken along line III-III in FIG. 2.

FIG. 4 is a flowchart illustrating a process for manufacturing the lithium-ion rechargeable battery.

FIG. 5 is a schematic cross-sectional view of the electrode body showing the negative electrode mixture layer that is expanded during charging.

FIG. 6 is a schematic cross-sectional view of the electrode body showing the negative electrode mixture layer that is contracted from the state of FIG. 5 during discharging.

FIG. 7 is a schematic plan view showing the crystal structure of α-graphite in a state in which the SOC is 0%.

FIG. 8 is a schematic plan view showing the crystal structure of LiC₆ in a state in which the SOC is 100%.

FIG. 9 is a diagram showing equation (1) that expresses the lattice volume of a crystal lattice extracted from α-graphite in a state in which the SOC is 0%.

FIG. 10 is a diagram showing equation (2) that expresses the lattice volume of a crystal lattice extracted from LiC₆ in a state in which the SOC is 100%.

FIG. 11 is a table showing the materials and physical property values of the positive plates, the negative plates, and the separators in the electrode bodies of examples 1 to 4 and comparative examples 1 to 3.

FIG. 12 is a table showing parameters and resistance increase rates subsequent to charge-discharge cycles in the electrode bodies of examples 1 to 4 and comparative examples 1 to 3.

FIG. 13 is a graph showing the relationship of the resistance increase rate subsequent to charge-discharge cycles with respect to parameter E.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

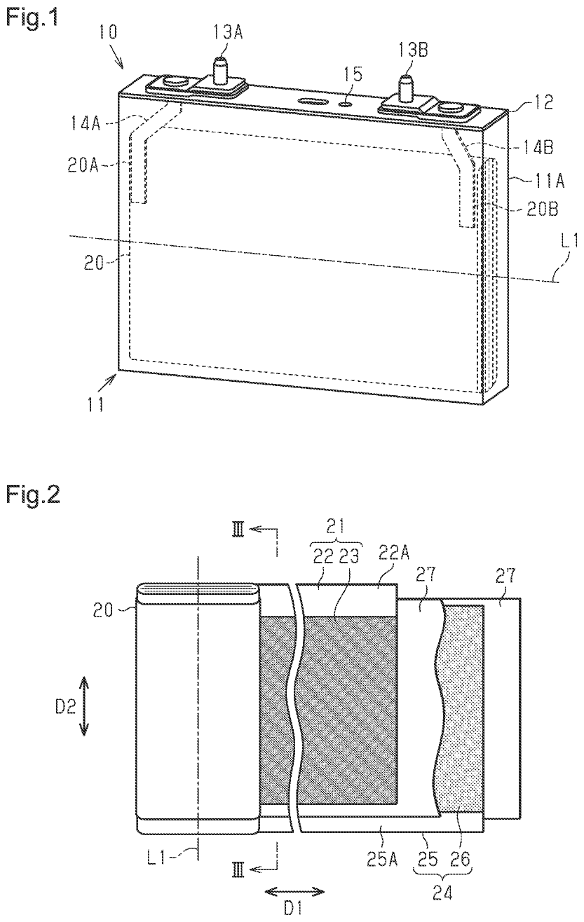

One embodiment of the present disclosure will now be described with reference to FIGS. 1 to 13.

### Lithium-Ion Rechargeable Battery

As shown in FIG. 1, a lithium-ion rechargeable battery 10, which is one example of non-aqueous rechargeable battery, includes a case 11 and an electrode body 20. The case 11 includes an accommodation compartment 11A and a lid 12. The accommodation compartment 11A is box-shaped and has an open upper end. The accommodation compartment 11A accommodates the electrode body 20 and a non-aqueous electrolyte solution. The lid 12 closes the open end of the accommodation compartment 11A. The case 11 forms a sealed battery casing when the lid 12 is attached to the accommodation compartment 11A. The case 11 is formed from a metal such as aluminum or an aluminum alloy.

A positive electrode external terminal 13A and a negative electrode external terminal 13B are arranged on the lid 12. The external terminals 13A and 13B are used to charge and discharge electric power. A positive electrode collector portion 20A, which is the positive electrode end of the electrode body 20, is electrically connected by a positive electrode collector member 14A to the external terminal 13A of the positive electrode. A negative electrode collector portion 20B, which is the negative electrode end of the electrode body 20, is electrically connected by a negative electrode collector member 14B to an external terminal 13B of the negative electrode. The lid 12 includes an inlet 15 through which a non-aqueous electrolyte solution is injected into the battery casing. The external terminals 13A and 13B do not have to be shaped as shown in FIG. 1 and may have any shape.

### Electrode Body

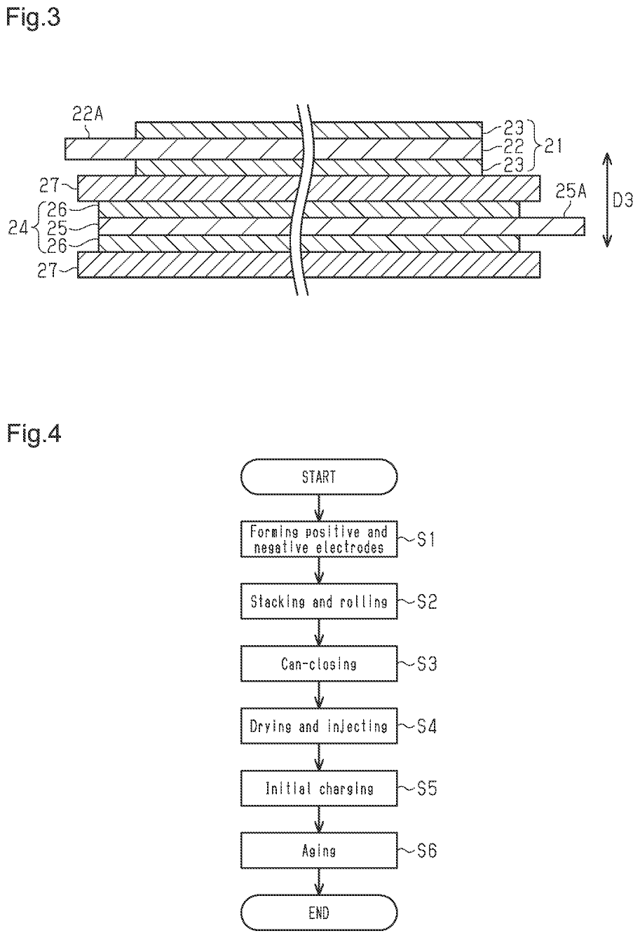

As shown in FIG. 2, the electrode body 20 is a flattened roll formed by rolling an elongated stack of a positive electrode plate 21, a negative electrode plate 24, and separators 27. The long sides of positive electrode plate 21, the negative electrode plate 24, and the separators 27 extend in a longitudinal direction D1. The positive electrode plate 21, one of the separators 27, the negative electrode plate 24, and another one of the separators 27 are sequentially stacked in a stacking direction D3 (refer to FIG. 3) to form the stack. Then, the stack is rolled. The strips of the positive electrode plate 21, the negative electrode plate 24, and the separators 27 located in between are rolled about a rolling axis L1, which extends in a widthwise direction D2 of the strips, to form the electrode body 20. Thus, the positive electrode plate 21 and the negative electrode plate 24 are each rolled into opposing parts, or layers, of the electrode body 20. In the same manner, the separators 27 are each rolled into opposing parts, or layers, of the electrode body 20.

### Positive Electrode Plate

As shown in FIG. 3, the positive electrode plate 21 includes a positive electrode substrate 22 and positive electrode mixture layers 23. The positive electrode substrate 22 has the form of an elongated foil. The positive electrode mixture layers 23 are applied to two surfaces of the positive electrode substrate 22 that face opposite directions. One end of the positive electrode substrate 22 in the widthwise direction D2 includes a positive electrode non-coated portion 22A where the positive electrode mixture layers 23 are not formed and the positive electrode substrate 22 is exposed.

A metal foil formed from aluminum or an alloy of which the main component is aluminum is used as the positive electrode substrate 22. Opposing parts, or layers, of the positive electrode non-coated portion 22A of the positive electrode substrate 22 in the roll are pressed against one other to form the positive electrode collector portion 20A.

The positive electrode mixture layers 23 are hardened bodies formed by drying a liquefied positive electrode mixture paste. The positive electrode mixture paste includes a positive electrode active material, a positive electrode solvent, a positive electrode conductive material, and a positive electrode binder. The positive electrode mixture layers 23 are formed by drying the positive electrode mixture paste and vaporizing the positive electrode solvent. Accordingly, the positive electrode mixture layers 23 include the positive electrode active material, the positive electrode conductive material, and the positive electrode binder.

The positive electrode active material is a lithium-containing composite metal oxide that allows for the occlusion and release of lithium ions, which serve as the charge carrier of the lithium-ion rechargeable battery 10. A lithium-containing composite metal oxide is an oxide containing lithium and a metal element other than lithium. The metal element other than lithium is, for example, one selected from a group consisting of nickel, cobalt, manganese, vanadium, magnesium, molybdenum, niobium, titanium, tungsten, aluminum, and iron contained as iron phosphate in the lithium-containing composite metal oxide.

The lithium-containing composite metal oxide is, for example, lithium cobalt oxide (LiCoO₂), lithium nickel oxide (LiNiO₂), or lithium manganese oxide (LiMn₂O₄). The lithium-containing composite metal oxide is, for example, a three-element lithium-containing composite metal oxide that contains nickel, cobalt, and manganese (NCM), that is, lithium nickel manganese cobalt oxide (LiNiCoMnO₂). The lithium-containing composite metal oxide is, for example, lithium iron phosphate (LiFePO₄).

The positive electrode solvent is an N-methyl-2-pyrrolidone (NMP) solvent, which is one example of an organic solvent. The positive electrode conductive material may be, for example, carbon black such as acetylene black (AB) or ketjen black, carbon nanotubes (CNT), carbon fiber such as carbon nanofiber, or graphite. One example of the positive electrode binder is a resin component contained in the positive electrode mixture paste. The positive electrode binder is, for example, polyvinylidene fluoride (PVDF), polyvinyl alcohol (PVA), styrene-butadiene rubber (SBR), or the like.

The positive electrode plate 21 may include an insulation layer at the boundary between the positive electrode non-coated portion 22A and each positive electrode mixture layer 23. The insulation layer contains an insulative inorganic component and a resin component that functions as a binder. The inorganic material is at least one selected from a group consisting of boehmite, titania, and alumina that are in powder forms. The resin component is at least one selected from a group consisting of PVDF, PVA, and an acrylic.

### Negative Electrode

The negative electrode plate 24 includes a negative electrode substrate 25 and negative electrode mixture layers 26. The negative electrode substrate 25 has the form of an elongated foil. The negative electrode mixture layers 26 are applied to two surfaces of the negative electrode substrate 25 that face opposite directions. One end of the negative electrode substrate 25 in the widthwise direction D2 that is the end located opposite the positive electrode non-coated portion 22A includes a negative electrode non-coated portion 25A where the negative electrode mixture layers 26 are not formed and the negative electrode substrate 25 is exposed.

A metal foil formed from copper or an alloy of which the main component is copper is used as the negative electrode substrate 25. Opposing parts, or layers, of the negative electrode non-coated portion 25A in the roll are pressed against one another to form the negative electrode collector portion 20B.

The negative electrode mixture layers 26 are hardened bodies formed by drying a liquefied negative electrode mixture paste. The negative electrode mixture paste includes a negative electrode active material, a negative electrode solvent, a negative electrode dispersant, and a negative electrode binder. The negative electrode mixture layers 26 is formed by drying the negative electrode mixture paste and vaporizing the negative electrode solvent. Accordingly, the negative electrode mixture layers 26 include the negative electrode active material, the negative electrode dispersant, and the negative electrode binder. The negative electrode mixture layers 26 may further include an additive such as a conductive material.

The negative electrode active material allows for the occlusion and release of lithium ions. The negative electrode active material is, for example, a carbon material such as graphite, hard carbon, soft carbon, or carbon nanotubes. The negative electrode active material may be composite particles that are graphite particles coated by an amorphous carbon layer. The graphite particles, which have a highly crystalline structure with layers of carbon hexagonal rings arranged one over another, are natural graphite and artificial graphite. Graphite particles are often spherical or oval. The amorphous carbon layer is formed on the surfaces of the graphite particles by heating and kneading amorphous carbon material, which is used as a precursor, together with the graphite particles. The amorphous carbon material is petroleum pitch, coal pitch, petroleum coke, coal coke, or a mixture of these substances. The kneaded material is dried under an inert atmosphere at a temperature lower than the graphitization temperature at which the precursor is graphitized. Then, the dried material is pulverized to separate the graphite particles. This generates the composite particles coated by an amorphous layer.

One example of the negative electrode solvent is water. One example of the negative electrode dispersant is carboxymethyl cellulose (CMC). The negative electrode binder may be the same as the positive electrode binder. One example of the negative electrode binder is SBR.

### Separator

The separators 27 prevent contact between the positive electrode plate 21 and the negative electrode plate 24, and hold the non-aqueous electrolyte solution between the positive electrode plate 21 and the negative electrode plate 24. Immersion of the electrode body 20 in the non-aqueous electrolyte solution results in the non-aqueous electrolyte solution permeating each separator 27 from the ends toward the center.

Each separator 27 is a nonwoven fabric of polypropylene or the like. The separator 27 may be, for example, a porous polymer film, such as a porous polyethylene film, a porous polyolefin film, or a porous polyvinyl chloride film. Alternatively, the separator 27 may be an ion conductive polymer electrolyte film or the like.

### Non-Aqueous Electrolyte Solution

The non-aqueous electrolyte solution is a composition containing support salt in a non-aqueous solvent. The non-aqueous solvent is, for example, one, two or more selected from the group consisting of propylene carbonate, ethylene carbonate, diethyl carbonate, dimethyl carbonate, ethyl methyl carbonate, and the like. The support salt may be, for example, a lithium compound (lithium salt) of one, two, or more selected from the group consisting of LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like.

In the present embodiment, ethylene carbonate is used as the non-aqueous solvent. Lithium bis(oxalate)borate (LiBOB), which is a lithium salt serving as an additive, is added to the non-aqueous electrolyte solution. For example, LiBOB is added to the non-aqueous electrolyte solution so that the concentration of LiBOB in the non-aqueous electrolyte solution is 0.001 mol/L or greater and 0.1 mol/L or less.

### Method for Manufacturing Lithium-Ion Rechargeable Battery

As shown in FIG. 4, a method for manufacturing the lithium-ion rechargeable battery 10 includes steps S1 to S6. Step S1 is an electrode formation step for forming each of the positive electrode plate 21 and the negative electrode plate 24. The formation step of the positive electrode plate 21 applies a positive electrode mixture paste to the two surfaces of the positive electrode substrate 22 facing opposite directions so as to form the positive electrode non-coated portion 22A at the two ends in the widthwise direction D2. Then, the positive electrode mixture paste is dried to form the positive electrode mixture layers 23. The positive electrode mixture layers 23 formed on the two surfaces of the positive electrode substrate 22 are then pressed to adjust the thickness of each positive electrode mixture layers 23. Then, the positive electrode substrate 22 is cut at the middle in the widthwise direction D2. In this manner, two positive electrode plates 21 are formed at the same time.

The formation step of the negative electrode plate 24 applies a negative electrode mixture paste to the two surfaces of the negative electrode substrate 25 facing opposite directions so as to form the negative electrode non-coated portion 25A at the two ends in the widthwise direction D2. Then, the negative electrode mixture paste is dried to form the negative electrode mixture layers 26. The negative electrode mixture layers 26 formed on the two surfaces of the negative electrode substrate 25 are pressed to adjust the thickness of each of the negative electrode mixture layers 26. Then, the negative electrode substrate 25 is cut at the middle in the widthwise direction D2. In this manner, two negative electrode plates 24 are formed at the same time.

Step S2 forms the electrode body 20 with the positive electrode plate 21, the negative electrode plate 24, and the separators 27. More specifically, the positive electrode plate 21 and the negative electrode plate 24 are stacked with the separators 27 located in between. Then, the stack is rolled and pressed into a flattened form. Further, opposing parts of the positive electrode non-coated portion 22A are pressed against one another to form the positive electrode collector portion 20A, and opposing parts of the negative electrode non-coated portion 25A are pressed against one another to form the positive electrode collector portion 20B. In this manner, the electrode body 20 is formed in step S2.

Step S3 is a can-closing step for accommodating the electrode body 20 in the case 11. The positive electrode collector portion 20A is electrically connected by the positive electrode collector member 14A to the external terminal 13A of the positive electrode. The positive electrode collector portion 20B is electrically connected by the negative electrode collector member 14B to the external terminal 13B of the negative electrode. The upper part of the accommodation compartment 11A is closed by the lid 12.

Step S4 is a drying step for removing moisture from the electrode body 20 through a heating process, and an injecting step for injecting a non-aqueous electrolyte solution into the case 11. The procedures described above produce the lithium-ion rechargeable battery 10.

Step S5 is a charging step for charging the lithium-ion rechargeable battery 10. Step S6 is an aging step that rests the lithium-ion rechargeable battery 10 subsequent to the charging step under a high temperature. The aging step dissolves metallic foreign matter and stabilizes the SEI film in the lithium-ion rechargeable battery 10. Then, the lithium-ion rechargeable battery 10 underdoes testing. This completes the manufacturing process of the lithium-ion rechargeable battery 10.

Increase in Battery Resistance Resulting from Charge-Discharge Cycle

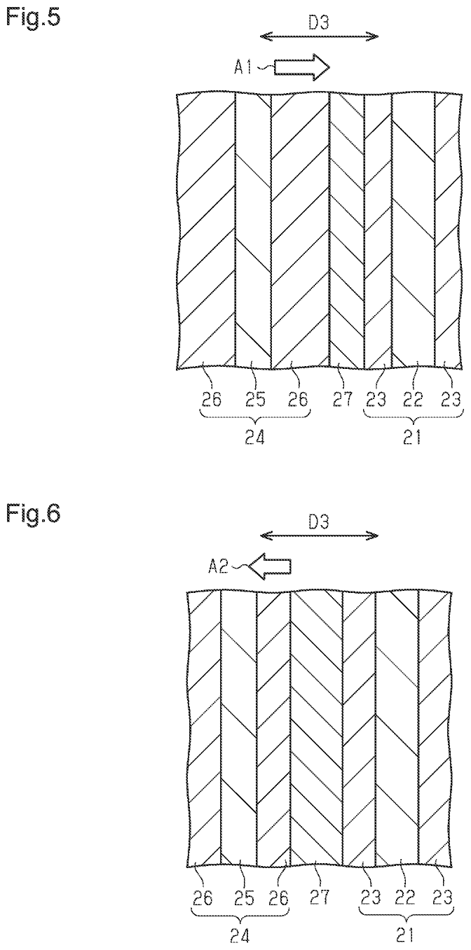

As shown in FIG. 5, when the lithium-ion rechargeable battery 10 is charged, lithium ions are occluded from the surface of the negative electrode active material into the negative electrode active material. This deforms the crystal gratings of the negative electrode active material and increases the volume of the negative electrode active material. Thus, when the lithium-ion rechargeable battery 10 is charged, the increase in the volume of the negative electrode mixture layers 26 presses the positive electrode plate 21 and the separators 27 in the direction of arrow A1, which extends in the stacking direction D3. Consequently, non-aqueous electrolyte solution is expelled from the positive electrode plate 21 and the separators 27 out of the electrode body 20.

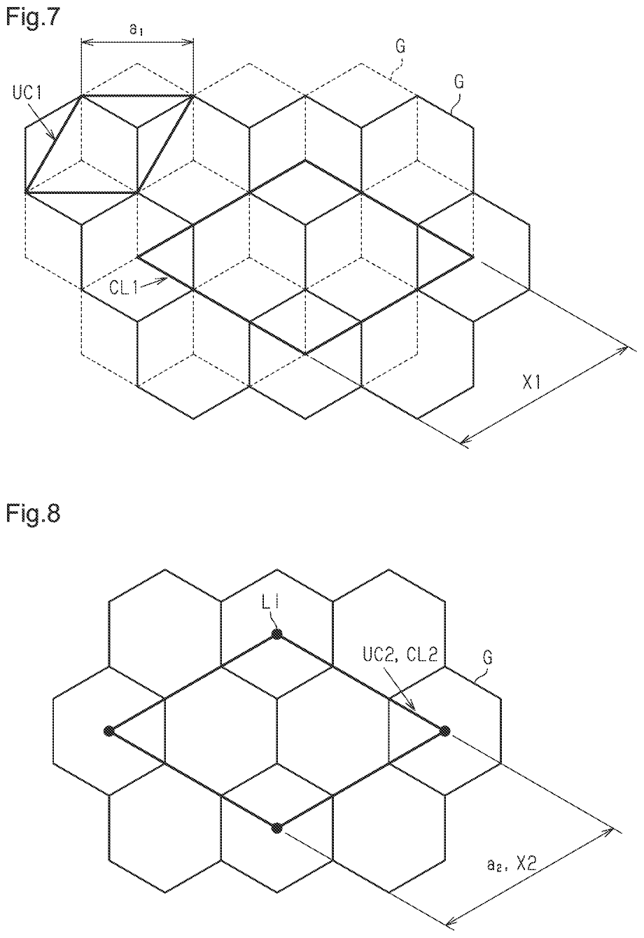

As shown in FIG. 6, when the lithium-ion rechargeable battery 10 is discharged, lithium ions are released from the negative electrode active material. This decreases the volume of the negative electrode active material. Consequently, when the lithium-ion rechargeable battery 10 is discharged, the decrease in the volume of the negative electrode mixture layers 26 in the direction of arrow A2, which extends in the stacking direction D3, expels the non-aqueous electrolyte solution from the negative electrode mixture layers 26 out of the electrode body 20.

When the lithium-ion rechargeable battery 10 is repeatedly charged and discharged, the negative electrode active material is repeatedly expanded and contracted. This expels non-aqueous electrolyte solution out of the electrode body 20. During charging, when the difference is large between the amount of non-aqueous electrolyte solution expelled out of the positive electrode plate 21 and the separators 27 and the amount of non-aqueous electrolyte solution expelled out of the negative electrode plate 24, the non-aqueous electrolyte solution will be distributed unevenly in the electrode body 20. Uneven distribution of the non-aqueous electrolyte solution in the electrode body 20 will result in the non-aqueous electrolyte solution inside the electrode body 20 becoming locally insufficient and cause an increase in the battery resistance. Such a situation is apt to occur especially when the lithium-ion rechargeable battery 10 is repeatedly charged and discharged at a high output (high rate).

To avoid uneven distribution of the non-aqueous electrolyte solution in the electrode body 20 of the lithium-ion rechargeable battery 10, parameters A to D, are used to determine the value of E so that the value of E is within a predetermined numerical value range. The value of E is expressed as E=A×B/(C×D).

The parameters of A to D will now be described. The value of A is the sum (mg/cm²) of the mass of the negative electrode active material included in the negative electrode mixture layers 26 per unit area on each surface of the negative electrode substrate 25 in an opposing layer of the negative electrode plate 24 in the electrode body 20. The value of A may be calculated, for example, using the areal capacity (mg/cm²) of the negative electrode mixture layers 26 per unit area when forming the negative electrode plate 24 in step S1 and the mass ratio of the negative electrode active material in the negative electrode mixture layers 26. For example, one of or both of the areal capacity of the negative electrode mixture layers 26 per unit area when forming the negative electrode plate 24 in step S1 or the mass ratio of the negative electrode active material in the negative electrode mixture layers 26 may be varied to change the value of A.

In order to ensure that the amount of non-aqueous electrolyte solution expelled out of the negative electrode plate 24 as a result of charging and discharging will not become overly small, the lower limit of A is greater than or equal to 7.0 mg/cm² or greater than or equal to 7.26 mg/cm². In order to ensure that the amount of non-aqueous electrolyte solution expelled from the negative electrode plate 24 as a result of charging and discharging will not become overly large, the upper limit of A is less than or equal to 10.0 mg/cm² or less than or equal to 9.41 mg/cm².

The value of B is the lattice volume change amount (nm³) of the negative electrode active material when the lithium-ion rechargeable battery 10 is charged from the state of charge (SOC) of 0% to 100%. For example, when the negative electrode active material is graphite, the unit lattice of α-graphite when the SOC is 0% differs in number of atoms and size of unit lattice from the unit lattice of LiC₆ when the SOC is 100% and lithium is occluded in the graphite.

As shown in FIG. 7, for example, α-graphite at an SOC of 0% is formed by stacked layers of graphene Ga with carbon atoms bonded into hexagonal nets. Referring to FIG. 7, in α-graphite, graphene G in an odd ordinal number layer, indicated by the solid lines, is located, in the planar direction of graphene G (two-dimensional direction), away from graphene G in an even ordinal number layer, indicated by broken lines. Further, a-axis lattice constant a₁ of unit lattice UC1 in α-graphite is √3 times greater than each side of a hexagonal ring (inter-carbon distance of hexagonal ring). Additionally, c-axis lattice constant c₁ of unit lattice UC1 in α-graphite is 2 times greater than the interplanar distance between adjacent graphene G in the c-axis direction that is the stacking direction of graphene G. Unit lattice UC1 of α-graphite includes four carbon atoms.

As shown in FIG. 8, LiC₆ at an SOC of 100% is an interlayer compound in which lithium (Li) is occluded between layers of graphene G of α-graphite. With LiC₆, the occlusion of lithium results in graphene G in an odd ordinal number layer being located, in the planar direction of graphene G, toward graphene G in an even ordinal number layer. Thus, the carbon atoms of graphene G overlap in the c-axis direction. Further, a-axis lattice constant a₂ of unit lattice UC2 in LiC₆ is 3 times greater than each side of a hexagonal ring. Additionally, c-axis lattice constant c₂ of unit lattice UC2 is the interplanar distance between adjacent graphene G in the c-axis direction. Unit lattice UC2 of LiC₆ includes six carbon atoms.

The lattice volume change amount of the negative electrode active material resulting from the occlusion of lithium extracts crystal lattices of the same carbon number from each of α-graphite at the SOC of 0% and LiC₆ at an SOC of 100%. The lattice volume change amount of the negative electrode active material is obtained by subtracting the volume of the crystal lattices extracted from α-graphite from the volume of crystal lattices extracted from LiC₆. In the calculation of the lattice volume change amount, the crystal lattices extracted from each of α-graphite and LiC₆ include, for example, twelve carbon atoms that is the least common multiple of the atom number included in the unit lattice UC1 of α-graphite and the atom number included in the unit lattice UC2 of LiC₆.

As shown in FIG. 7, crystal lattice CL1 extracted from α-graphite is a parallelepiped extending over three layers of graphene G and includes, for example, a rhombic top surface, a rhombic bottom surface, and four side surfaces connecting the top surface and the bottom surface. The top surface and the bottom surface are at the two outermost ones of the three layers, or the odd ordinal number layers of graphene G. The four sides of crystal lattice CL1 extending in the c-axis direction each overlap the carbon atoms located in the even ordinal number layer. The length X1 of each side of the rhombic top surface and bottom surface is 3 times greater than the length of each side of the hexagonal ring, and 43 times greater than the a-axis lattice constant a₁ of unit lattice UC1. Further, in crystal lattice CL1, the length of the four sides extending in the c-axis direction is 2 times greater than the interplanar distance between adjacent graphene G in the c-axis direction, and equal to the c-axis lattice constant c₁ of unit lattice UC1.

As shown in FIG. 8, crystal lattice CL2 extracted from LiC₆ is, for example, a parallelepiped in which two unit lattices UC2 of LiC₆ are arranged one over the other in the c-axis direction. Crystal lattice CL2 is a parallelepiped extending over three layers of graphene G and includes a rhombic top surface, a rhombic bottom surface, and four side surfaces connecting the top surface and the bottom surface. The top surface and the bottom surface are at the two outermost ones of the three layers. The four sides of crystal lattice CL2 extending in the c-axis direction overlap the lithium atoms occluded between the planes of graphene G. The length X2 of each side of the rhombic top surface and bottom surface is 3 times greater than the length of each side of the hexagonal ring, and equal to the a-axis lattice constant a₂ of unit lattice UC2. Further, in crystal lattice CL2, the length of the four sides in the c-axis direction is 2 times greater than the interplanar distance between adjacent graphene G in the c-axis direction, and 2 times greater than the c-axis lattice constant c₂ of unit lattice UC2.

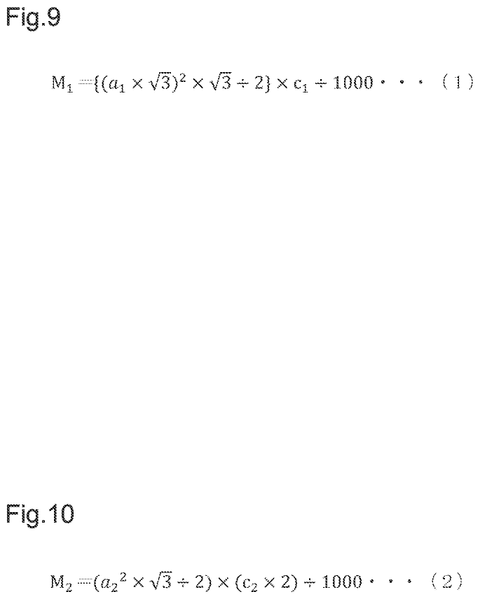

As shown in FIG. 9, for example, equation (1) expresses lattice volume M₁ (nm³) of crystal lattice CL1 extracted from α-graphite at an SOC of 00% using the a-axis lattice constant a₁ (angstrom) and the c-axis lattice constant c₁ (angstrom) of unit lattice UC1 in α-graphite.

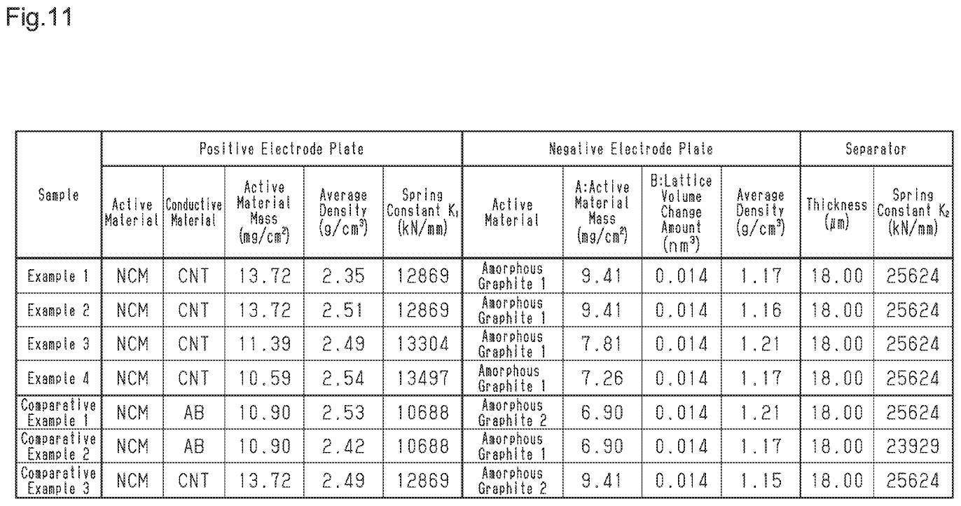

As shown in FIG. 10, for example, equation (2) expresses lattice volume M₂ (nm³) of crystal lattice CL2 extracted from LiC₆ at an SOC of 100% using the a-axis lattice constant a₂ (angstrom) and the c-axis lattice constant c₂ (angstrom) of unit lattice UC2 of LiC₆.

The a-axis lattice constant a₁ and the c-axis lattice constant c₁ of α-graphite can be obtained from peaks acquired through an X-ray diffraction (XRD) process conducted on the negative electrode active material at the SOC of 0% using the relationship between Bragg's law and the interplanar distance between Miller indices. In the same manner, a-axis lattice constant a₂ and c-axis lattice constant c₂ of LiC₆ can be obtained from peaks acquired through an XRD process conducted on the negative electrode active material at the SOC of 100% using the relationship between Bragg's law and the interplanar distance between Miller indices.

The value of B is expressed by subtracting the lattice volume M₁ (nm³) of crystal lattice CL1 at the SOC of 0% from the lattice volume M₂ (nm³) of crystal lattice CL2 at the SOC of 100%, or B=M₂−M₁. The value of B may be varied by, for example, changing the type of material used as the negative electrode active material. One example of the value of B is in a range of 0.013 nm³ to 0.016 nm³, inclusive.

With α-graphite, the lattice volume M₁ of crystal lattice CL1 is 3 times greater than the volume of unit lattice UC1. With LiC₆, the lattice volume M₂ of crystal lattice CL2 is 2 times greater than the volume of unit lattice UC2. Thus, the value of B may be obtained by subtracting 3 times the volume of unit lattice UC1 in α-graphite at the SOC of 0% from 2 times the volume of unit lattice UC2 in LiC₆ at the SOC of 100%.

In the present embodiment, X'Pert-PRO MPD (manufactured by Malvern Panalytical Ltd.) was used as the XRD measurement device. Further, PIXcel1D Detector (manufactured by Malvern Panalytical Ltd.) was used as the detector. A Cu target was used as the tube. The step width was 0.013°. The scanning width was 0.0417°/sec.

The value of A×B has a positive correlation with the volume change amount (increase amount) of the negative electrode active material included in the negative electrode mixture layers 26 per unit area when the lithium-ion rechargeable battery 10 is charged from the SOC of 0% to 100%. Further, the value of A×B has a positive correlation with the volume change amount (decrease amount) of the negative electrode active material included in the negative electrode mixture layers 26 per unit area when the lithium-ion rechargeable battery 10 is discharged from the SOC of 100% to 0%. Thus, the value of A×B has a positive correlation with the electrolyte solution expelled from the negative electrode plate 24 due to the expansion and contraction of the negative electrode active material resulting from the charging and discharging of the lithium-ion rechargeable battery 10. In other words, the value of A×B is an index indicating the amount of non-aqueous electrolyte solution expelled out of the negative electrode plate 24 due to the expansion and contraction of the negative electrode active material resulting from the charging and discharging of the lithium-ion rechargeable battery 10.

The negative electrode active material of the state of the electrode body 20 has a particle size (median size D50) of, for example, 5 μm or greater and 30 μm or less. A state in which the particle size of the negative electrode active material is in the above range is one example of a state in which the value of A×B has a positive correlation with the non-aqueous electrolyte solution expelled out of the negative electrode plate 24 due to the expansion and contraction of the negative electrode active material resulting from the charging and discharging of the lithium-ion rechargeable battery 10.

The value of C represents a change amount of the load (N) acting in the stacking direction D3 on the electrode body 20 when the lithium-ion rechargeable battery 10 is charged from the SOC of 0% to 100%. When charging the lithium-ion rechargeable battery 10, expansion of the negative electrode active material in the negative electrode mixture layers 26 causes load to act on the electrode body 20 in the stacking direction D3. Thus, the value of C is the load that acts on the positive electrode plate 21 and the separators 27 due to the expansion of the negative electrode active material when the lithium-ion rechargeable battery 10 is charged. In a state in which the lithium-ion rechargeable battery 10 and a load cell is held between two constraining plates, a change in load is measured with the load cell when the lithium-ion rechargeable battery 10 is charged from the SOC of 0% to the SOC of 100%. The measured value is used to calculate the value of C.

In order to ensure that the amount of non-aqueous electrolyte solution expelled out of the positive electrode plate 21 and the separators 27 as a result of charging and discharging will not become overly large, the upper limit of C, is for example, less than or equal to 1700 N, and preferably, less than or equal to 1699 N. In order to ensure that the amount of non-aqueous electrolyte solution expelled from the positive electrode plate 21 and the separators 27 as a result of charging and discharging will not become overly small, the lower limit of C, is for example, greater than or equal to 1650 N, and preferably, greater than or equal to 1652 N.

The value of D is the sum (mm/kN) of a reciprocal of a spring constant K₁ (kN/mm) of the positive electrode plate 21 in one opposing layer of the electrode body 20 and a reciprocal of a spring constant K₂ (kN/mm) of the separators 27 in one opposing layer of the electrode body 20 in the stacking direction D3. In other words, the value of D is the sum (mm/kN) of the reciprocal of the spring constant K₁ (kN/mm) in the thickness direction of the positive electrode plate 21 and the spring constant K₂ (kN/mm) in the thickness direction of the separators 27.

The spring constant K₁ of the positive electrode plate 21 may be obtained from a displacement amount when a predetermined load is applied in the stacking direction D3 to the positive electrode plate 21 that is in a state prior to formation of the electrode body 20. For example, positive electrode plates 21, in a state prior to the formation of the electrode body 20, are cut into sheets of samples sized 55 mm×90 mm that do not include the positive electrode non-coated portion 22A. Then, a load of 1500 kgf is applied to a stack of 65 sheets of samples in the stacking direction D3. Then, the spring constant K₁ of the positive electrode plate 21 for each sheet may be obtained from the displacement amount with respect to the load on the stack in a range from 1000 kgf to 1500 kgf. The spring constant K₁ of the positive electrode plate 21 may be varied by, for example, changing the amount of the positive electrode mixture layer 23 or by changing the thickness of the positive electrode mixture layer 23.

The spring constant K₂ of the separators 27 may be calculated in the same manner as the spring constant K₁ of the positive electrode plate 21. For example, the separators 27, in a state prior to the formation of the electrode body 20, are cut into sheets of samples sized 55 mm×90 mm. Then, a load of 1500 kgf is applied to a stack of 130 sheets of the samples in the stacking direction D3. Then, the spring constant K₂ of the separators 27 for each sheet may be obtained from the displacement amount with respect to the load on the stack in a range from 1000 kgf to 1500 kgf. The material or porosity (density) of the separators 27 may be changed to vary the spring constant K₂ of the separators 27.

In order to ensure that the amount of non-aqueous electrolyte solution expelled out of the positive electrode plate 21 and the separators 27 as a result of charging and discharging will not become overly small, the lower limit of D is greater than or equal to 0.00011 mm/kN or greater, and preferably, greater than or equal to 0.000113 mm/kN. In order to ensure that the amount of non-aqueous electrolyte solution expelled from the positive electrode plate 21 and the separators 27 as a result of charging and discharging will not become overly large, the upper limit of D is less than or equal to 0.00012 mm/kN, and preferably, less than or equal to 0.000117 mm/kN.

The value of C×D has a positive correlation with the displacement amount when expansion of the negative electrode active material during charging compresses the positive electrode plate 21 and the separators 27 in the stacking direction D3 and applies a load to the positive electrode plate 21 and the separators 27. That is, the value of C×D has a positive correlation with the volume change amount (decrease amount) of the positive electrode plate 21 and the separators 27 during charging. Thus, the value of C×D is an index indicating the amount of non-aqueous electrolyte solution expelled out of the positive electrode plate 21 and the separators 27 during charging and discharging.

The value of E is the ratio of A×B, which is the index indicating the amount of non-aqueous electrolyte solution expelled out of the negative electrode plate 24, to C×D, which is the index indicating the amount of non-aqueous electrolyte solution expelled out of the positive electrode plate 21 and the separators 27 during charging and discharging. Accordingly, the value of the value of E is an index indicating whether the non-aqueous electrolyte solution expelled out of the negative electrode plate 24 as a result of charging and discharging is properly balanced with the amount of the non-aqueous electrolyte solution expelled from the positive electrode plate 21 and the separators 27.

The lower limit for the value of E is greater than or equal to 0.48, preferably greater than or equal to 0.54, and more preferably greater than or equal to 0.56. When the value of E is greater than or equal to the lower limit, the amount of the non-aqueous electrolyte solution expelled from the amount of the non-aqueous electrolyte solution expelled from the positive electrode plate 21 and the separators 27 will not become overly large with respect to the amount of non-aqueous electrolyte solution expelled from the negative electrode plate 24 as a result of charging and discharging. In particular, when the value of E is greater than or equal to 0.56, increases in the resistance will be limited subsequent to charging and discharging cycles. The upper limit for the value of E is less than or equal to 0.69, and preferably, less than or equal to 0.68. When the value of E is less than or equal to the above upper limits, the amount of non-aqueous electrolyte solution expelled out of the negative electrode plate 24 will not become overly large with respect to the amount of the non-aqueous electrolyte solution expelled out of the positive electrode plate 21 and the separators 27 as a result of charging and discharging.

### EXAMPLES

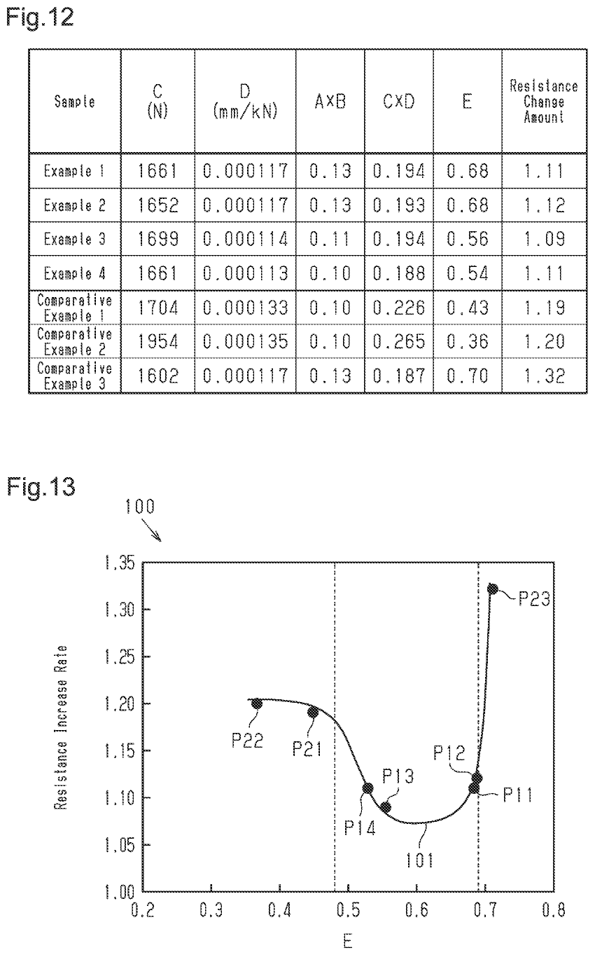

The relationship of the resistance increase rate subsequent to charge-discharge cycles with respect to the value of E will now be described using examples 1 to 4 and comparative examples 1 to 3. The examples given below are used to describe the advantages of the above embodiment and not intended to limit the present disclosure. The tables shown in FIGS. 11 and 12 list the materials and physical property values described below for the positive electrode plate 21, the negative electrode plate 24, and the separators 27 used in examples 1 to 4 and comparative examples 1 to 3.

With regard to the positive electrode plate 21, FIG. 11 shows the type of positive electrode active material and conductive material used for the positive electrode mixture layer 23, the sum of the mass (mg/cm²) of the positive electrode active material included in the positive electrode mixture layer 23 per unit area on each surface of the positive electrode substrate 22, the average density (g/cm³) of the positive electrode mixture layer 23, and the spring constant K₁ (kN/mm) of the positive electrode plate 21 in the stacking direction D3. With regard to the negative electrode plate 24, FIG. 11 shows the type of negative electrode active material in the negative electrode mixture layers 26, the sum of the mass (parameter A, mg/cm²) of the negative electrode active material included in the negative electrode mixture layer 26 per unit area on each surface of the negative electrode substrate 25, the lattice volume change amount (parameter B, nm³) of the negative electrode active material when charging the battery from the SOC of 0% to 100%, and the average density of the negative electrode mixture layers 26. In the table of FIG. 11, amorphous graphite 1 and amorphous graphite 2 were formed by performing a spheronization process on flakes of natural graphite and then coating the spherical graphite with amorphous graphite. Amorphous graphite 1 had a particle size (median size D50) of 11 μm. Amorphous graphite 2 had a particle size (median size D50) of 7 μm.

With regard to the separators 27, FIG. 11 shows the thickness of each separator 27 and the spring constant K₂ (kN/mm) of the separators 27 in the stacking direction D3. FIG. 12 shows parameter C (N), D (mm/kN), A×B, C×D, the value of E, and the resistance increase rate subsequent to charge-discharge cycles for examples 1 to 4 and comparative examples 1 to 3.

When measuring the resistance increase rate, under a temperature of 25° C., constant current charging at 30 C was performed for 10 seconds. Then, constant current charging at 3 C was performed for 100 seconds. This high-rate charge-discharge cycle was repeated 1600 times. The resistance after the first charge-discharge cycle and the resistance after 1600 cycles were measured. The resistance increase rate is the increase rate from the resistance after the first cycle to the resistance after 1600 cycles. Further, the resistance was calculated from the voltage drop at 10 seconds after starting discharging at 30 C from a state in which the battery was charged to the SOC of 60% under a temperature of 25° C.

### Example 1

In example 1, the spring constant K₁ of the positive electrode plate 21 in the stacking direction D3 was 12869 kN/mm. With regard to the negative electrode plate 24, the value of A was 9.41 mg/cm², and the value of B was 0.014 nm³. The spring constant K₂ of the separators 27 in the stacking direction D3 was 25624 kN/mm. Further, the value of C was 1661N, the value of D was 0.000117 mm/kN, the value of A×B was 0.13, the value of C×D was 0.194, and the value of E was 0.68.

### Example 2

In example 2, the spring constant K₁ of the positive electrode plate 21 in the stacking direction D3 was 12869 kN/mm. With regard to the negative electrode plate 24, the value of A was 9.41 mg/cm², and the value of B was 0.014 nm³. The spring constant K₂ of the separators 27 in the stacking direction D3 was 25624 kN/mm. Further, the value of C was 1652 N, the value of D was 0.000117 mm/kN, the value of A×B was 0.13, the value of C×D was 0.193, and the value of E was 0.68.

### Example 3

In example 3, the spring constant K₁ of the positive electrode plate 21 in the stacking direction D3 was 13304 kN/mm. With regard to the negative electrode plate 24, the value of A was 7.81 mg/cm², and the value of B was 0.014 nm³. The spring constant K₂ of the separators 27 in the stacking direction D3 was 25624 kN/mm. Further, the value of C was 1699 N, the value of D was 0.000114 mm/kN, the value of A×B was 0.11, the value of C×D was 0.194, and the value of E was 0.56.

### Example 4

In example 4, the spring constant K₁ of the positive electrode plate 21 in the stacking direction D3 was 13497 kN/mm. With regard to the negative electrode plate 24, the value of A was 7.26 mg/cm², and the value of B was 0.014 nm³. The spring constant K₂ of the separators 27 in the stacking direction D3 was 25624 kN/mm. Further, the value of C was 1661 N, the value of D was 0.000113 mm/kN, the value of A×B was 0.10, the value of C×D was 0.188, and the value of E was 0.54.

### Comparative Example 1

In comparative example 1, the spring constant K₁ of the positive electrode plate 21 in the stacking direction D3 was 10688 kN/mm. With regard to the negative electrode plate 24, the value of A was 6.90 mg/cm², and the value of B was 0.014 nm³. The spring constant K₂ of the separators 27 in the stacking direction D3 was 25624 kN/mm. Further, the value of C was 1704 N, the value of D was 0.000133 mm/kN, the value of A×B was 0.10, the value of C×D was 0.266, and the value of E was 0.43.

### Comparative Example 2

In comparative example 2, the spring constant K₁ of the positive electrode plate 21 in the stacking direction D3 was 10688 kN/mm. With regard to the negative electrode plate 24, the value of A was 6.90 mg/cm², and the value of B was 0.014 nm³. The spring constant K₂ of the separators 27 in the stacking direction D3 was 23929 kN/mm. Further, the value of C was 1954 N, the value of D was 0.000135 mm/kN, the value of A×B was 0.10, the value of C×D was 0.265, and the value of E was 0.36.

### Comparative Example 3

In comparative example 3, the spring constant K₁ of the positive electrode plate 21 in the stacking direction D3 was 12869 kN/mm. With regard to the negative electrode plate 24, the value of A was 9.41 mg/cm², and the value of B was 0.014 nm³. The spring constant K₂ of the separators 27 in the stacking direction D3 was 25624 kN/mm. Further, the value of C was 1602 N, the value of D was 0.000117 mm/kN, the value of A×B was 0.13, the value of C×D was 0.187, and the value of E was 0.70.

### Evaluation

As shown in FIG. 13, points P11 to P14 plotted in graph 100 show the relationship of the resistance increase rate with respect to the value of E in examples 1 to 4. Points P21 to P23 plotted in graph 100 show the relationship of the resistance increase rate with respect to the value of E in comparative examples 1 to 3. Curve 101 in graph 100 is an approximate curve based on points P11 to P14 and points P21 to P23 and show changes in the resistance increase rate with respect to the value of E.

In examples 1 to 4, the value of E was in the range of 0.48 to 0.69, inclusive. The resistance increase rate of the charge-discharge cycle after the charge-discharge cycles was 1.09 to 1.12. In particular, the resistance increase rate after the charge-discharge cycles was the lowest in example 3 in which the value of E was 0.56.

In comparative examples 1 and 2, the value of E was less than 0.48. The resistance increase rate after the charge-discharge cycles was 1.19 to 1.20. Thus, the resistance increase rate after the charge-discharge cycles was higher in comparative examples 1 and 2 than in examples 1 to 4. The resistance increase rate in comparative examples 1 and 2 increased because the amount of non-aqueous electrolyte solution expelled out of the negative electrode plate 24 as a result of charging and discharging was less than the amount of the non-aqueous electrolyte solution expelled out of the positive electrode plate 21 and the separators 27.

In comparative example 3 in which the value of E was greater than 0.69, the resistance increase rate after the charge-discharge cycles was 1.32. Thus, the resistance increase rate after the charge-discharge cycles was higher in comparison example 3 than in examples 1 to 4. The resistance increase rate in comparative example 3 increased because the amount of the non-aqueous electrolyte solution expelled out of the positive electrode plate 21 and the separators 27 as a result of charging and discharging was less than the amount of the non-aqueous electrolyte solution expelled out of the negative electrode plate 24. As described above, the resistance increase rate after the charge-discharge cycles was limited when the value of E was set in the range of 0.48 to 0.69, inclusive.

### Advantages of the Embodiment

The advantages of the above embodiment will now be described.
(1) By setting the value of E within a proper range, the amount of non-aqueous electrolyte solution expelled out of the negative electrode plate 24 as a result of charging and discharging will be properly balanced with the amount of the non-aqueous electrolyte solution expelled out of the positive electrode plate 21 and the separators 27. In particular, as long as the value of E is greater than or equal to 0.56, an increase in the resistance of the lithium-ion rechargeable battery 10 resulting from the charge-discharge cycle can be avoided.
(2) By setting the value of C to less than or equal to 1700 N, preferably, less than or equal to 1699 N, the amount of the non-aqueous electrolyte solution expelled out of the positive electrode plate 21 and the separators 27 as a result of charging and discharging will not become overly large. By setting the value of C to greater than or equal to 1650 N or greater than or equal to 1652 N, the amount of the non-aqueous electrolyte solution expelled from the positive electrode plate 21 and the separators 27 as a result of charging and discharging will not become overly small.
(3) By setting the value of A to greater than or equal to 7.0 mg/cm², preferably, greater than or equal to 7.26 mg/cm², the amount of non-aqueous electrolyte solution expelled out of the negative electrode plate 24 as a result of charging and discharging will not become overly large. By setting the value of A to less than or equal to 10.0 mg/cm², preferably, less than or equal to 9.41 mg/cm², the amount of non-aqueous electrolyte solution expelled out of the negative electrode plate 24 as a result of charging and discharging will not become overly small.
(4) By setting the value of D to greater than or equal to 0.00011 mm/kN, preferably, greater than or equal to 0.000113 mm/kN, the amount of the non-aqueous electrolyte solution expelled out of the positive electrode plate 21 and the separators 27 as a result of charging and discharging will not become overly small. By setting the value of D to less than or equal to 0.00012 mm/kN, preferably, less than or equal to 0.000117 mm/kN, the amount of the non-aqueous electrolyte solution expelled out of the positive electrode plate 21 and the separators 27 will not become overly large.

### Modified Examples

The above embodiment may be modified as described below.

As long as the amount of non-aqueous electrolyte solution expelled out of the negative electrode plate 24 as a result of charging and discharging can be properly balanced with the amount of the non-aqueous electrolyte solution expelled out of the positive electrode plate 21 and the separators 27, there is no limitation to the value of C and the value of D. For example, the value of C can be less than 1650 N, and the value of C can be greater than 1700 N. For example, the value of D can be less than 0.00011 mm/kN, and the value of D can be greater than 0.00012 mm/kN.

As long as the amount of the non-aqueous electrolyte solution expelled out of the positive electrode plate 21 and the separators 27 can be properly balanced with the amount of the non-aqueous electrolyte solution expelled out of the negative electrode plate 24, there is no limitation to the value of A and the value of B. For example, the value of A may be less than 7.0 mg/cm², and the value of A may be greater than 10.0 mg/cm². For example, the value of B may be less than 0.013 nm³, and the value of B may be greater than 0.016 nm³.

There is no limitation to the value of E as long as it is within the range of 0.48 to 0.69, inclusive. For example, the value of E may be greater than or equal to 0.48 and less than 0.56.

The electrode body 20 does not have to be a roll and may be a stack of the positive electrode plate 21, the negative electrode plate 24, and the separators 27 accommodated in the case 11.

The lithium-ion rechargeable battery 10 may be another type of non-aqueous rechargeable battery such as a nickel metal hydride battery.

The lithium-ion rechargeable battery 10 may be used in an automatic transporting vehicle, a special hauling vehicle, a battery electric vehicle, a hybrid electric vehicle, a computer, an electronic device, or any other systems. For example, the lithium-ion rechargeable cell 10 may be used in a marine vessel, an aircraft, or any other type of movable body. The lithium-ion rechargeable battery 10 may also be used in a system that supplies electric power from a power plant via a substation to buildings and households.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A non-aqueous rechargeable battery, comprising:
an electrode body including a positive electrode plate, a negative electrode plate, and a separator that are stacked in a stacking direction, the separator being located between the positive electrode plate and the negative electrode plate; and
a non-aqueous electrolyte solution,
wherein the negative electrode plate includes a negative electrode substrate and a negative electrode mixture layer applied to two surfaces of the negative electrode substrate that face opposite directions,
when A represents a sum of a mass (mg/cm²) of a negative electrode active material included in the negative electrode mixture layer per unit area on each of the surfaces of the negative electrode substrate,
B represents a lattice volume change amount (nm³) of the negative electrode active material when the non-aqueous rechargeable battery is charged from an SOC 0% to 100%,
C represents a change amount of the load (N) acting in the stacking direction on the electrode body when the non-aqueous rechargeable battery is charged from the SOC of 0% to 100%,
D represents a sum (mm/kN) of a reciprocal of a spring constant of the positive electrode plate and a reciprocal of the spring constant of the separator in the stacking direction, and
E=A×B/(C×D) is satisfied,
E has a value in a range of 0.48 to 0.69, inclusive.

2. The non-aqueous rechargeable battery according to claim 1, wherein E has a value of 0.56 or greater.

3. The non-aqueous rechargeable battery according to claim 1, wherein C has a value in a range of 1650 N to 1700 N, inclusive.

4. The non-aqueous rechargeable battery according to claim 3, wherein A has a value in a range of 7.0 mg/cm² to 10.0 mg/cm², inclusive.

5. The non-aqueous rechargeable battery according to claim 4, wherein D has a value of 0.00011 mm/kN to 0.00012 mm/kN, inclusive.
